(19) United States
(12) Patent Application Publication
(10) Pub. No.: US 2025/0130574 A1
(43) Pub. Date: Apr. 24, 2025

(54) AUTONOMOUS VEHICLE DRIVING SYSTEM AND METHOD

(71) Applicant: Guangzhou Tufa network technology Co., LTD, Guangzhou (CN)

(72) Inventors: Chengxiang YAO, Guangzhou (CN); Qiushi HUANG, Guangzhou (CN); Wei XIANG, Guangzhou (CN)

(73) Assignee: Guangzhou Tufa network technology Co., LTD, Guangzhou (CN)

(21) Appl. No.: 18/983,240

(22) Filed: Dec. 16, 2024

Related U.S. Application Data
(63) Continuation of application No. PCT/CN2024/104136, filed on Jul. 8, 2024.

(30) Foreign Application Priority Data
Oct. 10, 2023 (CN) 202311310170.5
Jun. 26, 2024 (CN) 202410836303.0

(51) Int. Cl. G05D 1/243; B62J 45/20; B62J 45/41; G01S 13/931; G01S 17/931; G05D 1/617; G05D 111/10; G05D 111/50

(52) U.S. Cl. CPC G05D 1/243; B62J 45/20; B62J 45/41; G01S 13/931; G01S 17/931; G05D 1/617; G05D 2111/10; G05D 2111/52

(57) ABSTRACT

This disclosure provides an autonomous vehicle driving system and method. A vehicle may be located by using a vehicle-determined location determined by a vehicle-side locator based on a differential operation and an environmental image captured by an image sensor, that is, a current vehicle location of the vehicle is determined, so that accuracy of vehicle locating is ensured. Further, vehicle driving may be controlled based on the current vehicle location and environmental sensing data, and thus autonomous driving can be implemented without a LiDAR during vehicle operation, thereby reducing costs without affecting the appearance and use of the vehicle.

### RELATED APPLICATIONS

This application is a continuation application of PCT application No. PCT/CN2024/104136, filed on Jul. 8, 2024, which claims the benefit of priority of Chinese application numbers CN 2023113101705 filed on Oct. 10, 2023, and CN 2024108363030 filed on Jun. 26, 2024, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of vehicle technologies, and in particular, to an autonomous vehicle driving system and method.

### BACKGROUND

With development of science and technology, various commuter vehicles have appeared in people's lives, bringing great convenience to people's lives. In particular, short-distance commuter vehicles, such as kick scooters, tricycles, and self-balancing scooters, are increasingly used. People can drive commuter vehicles while standing thereon. The commuter vehicles are small and light, suitable for traveling in narrow space, and have great advantages in ultra-short-distance travel. To further save parking time of a short-distance commuter vehicle, the commuter vehicle may be driven to park in a permitted area by using an autonomous driving system and method. In the existing technology, most autonomous driving apparatuses use mechanical LiDARs, featuring high costs, complex structures, and large device sizes, which affect the appearance and use of vehicles. Those autonomous driving apparatuses are not suitable for short-distance commuter vehicles.

Therefore, a new autonomous driving system and method for a vehicle need to be provided to resolve the foregoing problems.

Content of the background section is only information known to the inventor personally, and neither represents that the information has entered the public domain before the filing date of this disclosure, nor represents that it can become the prior art of this disclosure.

### SUMMARY

The present disclosure provides an autonomous vehicle driving system and method to resolve problems existing in the related art.

According to a first aspect, this disclosure provides an autonomous vehicle driving system, including: a sensing device including an image sensor, where the sensing device is configured to output environmental sensing data; a locating device, including: a vehicle-side locator, configured to determine a vehicle-determined location of a vehicle based on a differential operation, and the image sensor, configured to capture an environmental image of a driving environment of the vehicle, where the vehicle-determined location and the environmental image are used to determine a current vehicle location of the vehicle; and a control device, configured to control vehicle driving based on the current vehicle location and the environmental sensing data.

According to a second aspect, this disclosure provides an autonomous vehicle driving method for an autonomous driving system, including: determining a current vehicle location of a vehicle based on a vehicle-determined location of the vehicle and an environmental image of a driving environment of the vehicle; determining environmental sensing data around the vehicle based on the environmental image; and controlling vehicle driving based on the current vehicle location and the environmental sensing data.

In summary, according to the autonomous vehicle driving system and method provided in this disclosure, a vehicle can be located by using the vehicle-side location determined by the vehicle-side locator based on the differential operation and the environmental image captured by the image sensor, that is, the current vehicle location of the vehicle can be determined, so that accuracy of vehicle locating is ensured. Further, vehicle driving is controlled based on the current vehicle location and the environmental sensing data, and autonomous driving can be implemented without a LIDAR during vehicle operation, thereby reducing costs without affecting the appearance and use of the vehicle.

Other functions of the autonomous vehicle driving system and method provided in this disclosure are partially listed in the following description. Based on the description, content described in the following figures and examples would be obvious to a person of ordinary skill in the art. Creative aspects of the autonomous vehicle driving system and method provided in this disclosure may be fully understood by practicing or using the method, apparatus, and a combination thereof provided in the following detailed examples.

### BRIEF DESCRIPTION OF THE DRAWINGS

To describe the technical solutions in the embodiments of this disclosure more clearly, the following briefly describes the accompanying drawings required for describing the embodiments. Apparently, the accompanying drawings in the following description show merely some exemplary embodiments of this disclosure, and a person of ordinary skill in the art may still derive other drawings from these accompanying drawings without creative efforts.

FIG. 1 is a system diagram of an autonomous vehicle driving system according to some exemplary embodiments of this disclosure;

FIG. 2 is a front view of a vehicle according to some exemplary embodiments of this disclosure;

FIG. 3 is a first perspective view of a vehicle according to some exemplary embodiments of this disclosure;

FIG. 4 is a second perspective view of a vehicle according to some exemplary embodiments of this disclosure;

FIG. 5 is a flowchart of an autonomous vehicle driving method according to some exemplary embodiments of this disclosure; and

FIG. 6 is a schematic flowchart of an autonomous vehicle driving method according to some exemplary embodiments of this disclosure.

### DETAILED DESCRIPTION

The following description provides specific application scenarios and requirements of this disclosure, to enable a person skilled in the art to make and use content of this disclosure. Various partial modifications to the disclosed exemplary embodiments would be obvious to a person skilled in the art. General principles defined herein can be applied to other embodiments and applications without departing from the spirit and scope of this disclosure. Therefore, this disclosure is not limited to the illustrated embodiments, but is to be accorded the widest scope consistent with the claims.

The terms used herein are only intended to describe specific exemplary embodiments and are not restrictive. For example, as used herein, singular forms “a”, “an”, and “the” may also include plural forms, unless otherwise clearly specified in a context. When used in this disclosure, the terms “comprise”, “include”, and/or “contain” indicate the presence of associated features, integers, steps, operations, elements, and/or components, but do not exclude the presence of one or more other features, integers, steps, operations, elements, components, and/or groups or addition of other features, integers, steps, operations, elements, components, and/or groups to the system/method.

In view of the following description, these features and other features of this disclosure, operations and functions of related elements of structures, and economic efficiency in combining and manufacturing components can be significantly improved. All of these form a part of this disclosure with reference to the drawings. However, it should be understood that the drawings are only for illustration and description purposes and are not intended to limit the scope of this disclosure. It should also be understood that the drawings are not drawn to scale.

Flowcharts used in this disclosure show operations implemented by a system according to some exemplary embodiments of this disclosure. It should be understood that operations in the flowcharts may be implemented not in the order as shown. Conversely, the operations may be implemented in a reverse order or simultaneously. In addition, one or more other operations may be added to the flowcharts, and one or more operations may be removed from the flowcharts.

In this disclosure, “X includes at least one of A, B, or C” means: X includes at least A, or X includes at least B, or X includes at least C. In other words, X may include only any one of A, B, and C, or may include any combination of A, B, and C, and other possible content or elements. Any combination of A, B, and C may be A, B, C, AB, AC, BC, or ABC.

In this disclosure, unless explicitly stated otherwise, an association relationship between structures may be a direct association relationship or an indirect association relationship. For example, in the description of “A is connected to B”, unless it is explicitly stated that A is directly connected to B, it should be understood that A may be directly connected to B or indirectly connected to B. In another example, in the description of “A is above B”, unless it is explicitly stated that A is directly above B (A and B are adjacent and A is above B), it should be understood that A may be directly above B or indirectly above B (A and B are separated by another element and A is above B). The rest may be inferred by analogy. In the present disclosure, the term “commuter vehicle” refers to any type of transportation designed primarily for short-distance travel, typically for daily commutes to and from work, school, or other regular destinations. Commuter vehicles in the present disclosure are intended to provide convenience, efficiency, and reliability for frequent use and can include a wide range of modes of transport such as, but not limited to, bicycles, electric bikes, scooters (e.g., kick scooters, mobility scooters, and electric scooters), self-balancing personal transporters (e.g., self-balancing scooters, hoverboards, self-balancing unicycles), motorcycles, compact cars, and personal mobility devices, etc.

When low-speed autonomous driving vehicles are faced with complex road conditions, the autonomous driving costs are generally high, which hinders practical application and commercial promotion of the autonomous driving vehicles in the market. For example, most low-speed short-distance commuter vehicles are equipped with LiDARs, such as mechanical LiDARs and solid-state LiDARs (such as hybrid solid-state LiDARs and pure solid-state LiDARs), the purpose of which is to use the LiDARs for positioning and navigation during vehicle operation. However, the LiDARs are large in size, very unfriendly to product design, and prone to damage under some harsh operating conditions. For example, LiDARs installed on shared three-wheel electric vehicles are prone to damage under bumpy road conditions, or prone to damage, or even loss, caused by human issues. Therefore, frequent maintenance by operators is required, and maintenance costs are high. Moreover, the LiDARs are susceptible to rain and fog, and are not sufficiently safe. Furthermore, prices of the LiDARs are relatively high, and sometimes even higher than prices of the vehicles, resulting in high costs for the entire autonomous driving system. Once the LiDARs are damaged, a manufacturer may be unable to recover the costs. This hinders promotion of autonomous driving vehicles in the market.

To achieve a balance between costs, safety, and maintainability, this disclosure provides an autonomous vehicle driving system and method without using a LiDAR during vehicle operation. A vehicle may be located by using a vehicle-side location determined by a vehicle-side locator based on a differential signal and an environmental image captured by an image sensor, and vehicle driving is controlled based on a current vehicle location and environmental sensing data. In this way, autonomous driving is achieved based on the location determined by the differential signal and vision. There is no need to use a LIDAR during operation, and a cost budget thus can be very low. Therefore, the return on operation can be increased, safety of autonomous driving can be ensured, and maintenance costs can be reduced, without affecting the appearance and use of the vehicle.

The autonomous vehicle driving system and method provided in this disclosure may be used in a vehicle, and in particular, a short-distance commuter vehicle, for example, a kick scooter, a tricycle, or a self-balancing scooter. The vehicle is small in size and light in weight, and is very suitable for short-distance travel. The vehicle may be a low-speed driving vehicle, for example, a vehicle driving at a low speed on a road in a half-/full-closed area (such as a university, a scenic spot, a park, or a community) or on a sidewalk or non-motorized vehicle lane on a public road. The vehicle described in this disclosure may be a private vehicle or a public vehicle, such as a shared bicycle or a public commuter vehicle.

The autonomous vehicle driving system and method provided in this disclosure may be used to automatically control the vehicle, to control the vehicle to drive along a predetermined route. The autonomous vehicle driving system and method can control the vehicle to drive between different locations, for example, control the vehicle to drive to a designated location, or for example, control the vehicle to drive from a non-parking place to a designated parking place, or control the vehicle to drive from a parking place to a location of a user. The autonomous vehicle driving system and method provided in this disclosure may be applied to a variety of different scenarios.

The autonomous vehicle driving system and method provided in this disclosure may be used to park a public vehicle in a permitted area. Public vehicles (such as short-distance commuter vehicles) are very suitable for short-distance travel to provide solutions between public transportation stations such as metro stations, high-speed railway stations, and bus stations, or a distance problem between stations and companies or homes. Currently, to prevent a problem that traffic order is affected by random parking of short-distance commuter vehicles, public parking areas dedicated to parking short-distance commuter vehicles have been planned in many cities. It will take users extra time to park their vehicles in public parking areas, which weakens advantages of short-distance commuter vehicles. To further save time for the user, the autonomous vehicle driving system and method provided in this disclosure can park the vehicle in a public parking area by using an autonomous driving technology, and control the public vehicle to autonomously drive from a non-public parking area to a public parking area, without requiring the user to spend time on it. The user only needs to park the vehicle at a destination, and the vehicle can drive to the public parking area by using the autonomous driving system and method.

The autonomous vehicle driving system and method provided in this disclosure may be used for station scheduling for public vehicles (such as shared bicycles). For example, when there are few vehicles at a station (public parking area) and the vehicles are not enough for use for nearby users, the autonomous vehicle driving system and method provided in this disclosure can control the public vehicles to autonomously drive from one public parking area to another public parking area by using the autonomous driving technology, thereby performing vehicle scheduling between stations and reducing costs of human scheduling.

The autonomous vehicle driving system and method provided in this disclosure may be used to park a private vehicle (such as an electric vehicle or a motorcycle) in a permitted area. For example, in a community of the user, there is a parking area dedicated to parking private vehicles of all residents of the community, or a dedicated parking space dedicated to parking the private vehicle of the user. To save time for the user, when the user parks the private vehicle in a non-designated parking area, the autonomous vehicle driving system and method provided in this disclosure can control the private vehicle to autonomously drive from the non-designated parking area to a designated parking area by using the autonomous driving technology. The designated parking area includes a dedicated parking space for the private vehicle and any vacant parking space in a parking area in which the private vehicle is permitted to park.

Certainly, the autonomous vehicle driving system and method provided in this disclosure may also be applied to other scenarios. For example, fully autonomous driving in a manned state transports the user to a designated destination. For example, remotely controlled autonomous driving drives the vehicle to a designated location. In another example, in remotely controlled autonomous parking, autonomous parking is remotely controlled in an emergency or when there is trouble in autonomous driving. In another example, for autonomous driving in a logistics scenario, a logistics vehicle autonomously transports goods to a destination.

A short-distance commuter vehicle is advantageous for its small size and light weight, and is characterized by a low running speed. However, autonomous driving apparatuses in the existing technology are mostly based on mechanical LiDARs. Such devices are large in size, expensive, and difficult to maintain. They are applicable to high-speed vehicles such as cars, but not applicable to short-distance commuter vehicles.

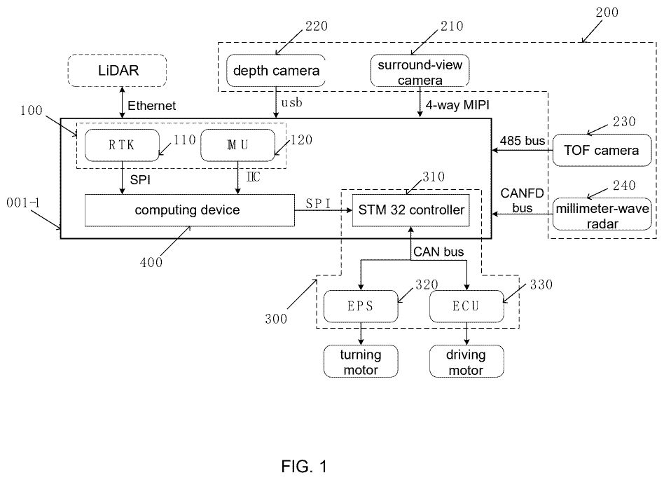

FIG. 1 is a system diagram of an autonomous vehicle driving system 001 according to some exemplary embodiments of this disclosure. As shown in FIG. 1, the system 001 includes a locating device 100, a sensing device 200, and a control device 300. The system 001 may further include a computing device 400.

The locating device 100 may include a vehicle-side locator 110 and an image sensor 210. The vehicle-side locator 110 is configured to determine a vehicle-side location of a vehicle based on a differential operation on a vehicle side. The image sensor 210 is configured to capture an environmental image of a current driving environment of the vehicle. The vehicle-side location and the environmental image may be used to determine a current vehicle location of the vehicle. The sensing device 200 may include the image sensor 210. The sensing device 200 is configured to output environmental sensing data. The control device 300 is configured to control vehicle driving based on the current vehicle location and the environmental sensing data.

In some exemplary embodiments, the vehicle-side locator 110 may be a differential locator, that is, the vehicle-side locator 110 may determine the vehicle-side location of the vehicle based on the differential operation on the vehicle side. For example, as shown in FIG. 1, the vehicle-side locator 110 is an RTK (real-time kinematic) carrier phase differential locator (RTK locator for short). The RTK locator may improve location accuracy of vehicle locating by using differential GPS (global positioning system) signals. Specifically, the RTK locator may receive a carrier signal sent by a satellite, and a reference station may also receive a carrier signal sent by the satellite. The reference station may broadcast the received carrier signal. Therefore, the RTK locator may also receive the carrier signal sent by the reference station. The reference station is a base station that provides a reference basis and assists the RTK locator in locating. Three-dimensional coordinate information of the reference station is generally known. The RTK locator may perform a differential operation on the carrier signal received from the satellite and the carrier signal received from the reference station to obtain the vehicle-side location of the vehicle. For example, the RTK locator may first solve a spatial relative position relationship between the RTK locator and the reference station through the differential operation, and then convert the spatial relative position relationship into the vehicle-side location (such as three-dimensional coordinates) of the vehicle through coordinate conversion. As shown in FIG. 1, the RTK locator may be connected to the computing device 400 via a serial port. The RTK locator may send the determined vehicle-side location to the computing device 400. The vehicle-side locator 110 may alternatively be other types of differential locators, such as a code differential locator. This is not limited in the embodiments of this disclosure.

In some exemplary embodiments, the vehicle-side locator 110 may be a GPS locator. The GPS locator may receive a signal sent by the satellite, obtain a time difference between sending the satellite signal from the satellite and receiving the satellite signal by the GPS locator, calculate a distance between the vehicle and the satellite based on the time difference and the speed of light, and hence determine the vehicle-side location of the vehicle based on the distance.

As shown in FIG. 1, the system 001 includes the image sensor 210. In some exemplary embodiments, the image sensor 210 may be a surround-view camera. The surround-view camera includes a plurality of (such as 3, 4, 5, or 7) cameras. By stitching images captured by the plurality of cameras, a panoramic image around the vehicle may be formed. In this way, vehicle driving free of blind spots, panoramic parking, and the like are achieved, and safety of vehicle driving is improved. The plurality of cameras in the surround-view camera may be wide-angle cameras, and the plurality of cameras may synchronously capture images when the vehicle is in operation. The surround-view camera may communicate with an internal system 001-1 of the system 001 via a MIPI (mobile industry processor interface). In some exemplary embodiments, the surround-view camera may include four cameras, such as four RGB cameras. Each RGB camera is a standard color camera that can capture images of three color channels: red, green, and blue, that is, each RGB camera can capture RGB images. The four RGB cameras may communicate with the internal system 001-1 via a 4-way MIPI. Models of different RGB cameras may be the same or different. The models of the RGB cameras are not limited herein. Any models of RGB cameras are within the protection scope of this disclosure. Certainly, the surround-view camera may also include other types of cameras. This is not limited herein.

In some exemplary embodiments, the image sensor 210 may be other types of sensors, such as a non-surround-view camera, and a viewing angle of the non-surround-view camera may be 180 degrees, 270 degrees, or the like. The type of the image sensor 210 is not limited herein.

In this disclosure, the image sensor 210 may be configured to determine the current vehicle location of the vehicle and also configured to determine the environmental sensing data. In other words, the locating device 100 may include the image sensor 210, and the sensing device 200 may also include the image sensor 210. For ease of drawing, FIG. 1 does not show that the locating device 100 includes the image sensor 210.

In some exemplary embodiments of this disclosure, the vehicle may be located by using the vehicle-side location determined by the vehicle-side locator 110 based on the differential operation and the environmental image captured by the image sensor 210, so that accuracy of vehicle locating is ensured. Further, vehicle driving may be controlled based on the current vehicle location and environmental sensing data, and autonomous driving can be implemented without a LIDAR during vehicle operation, thereby reducing costs without affecting the appearance and use of the vehicle. In some exemplary embodiments of this disclosure, when the vehicle-side locator 110 is an RTK locator, the system 001 may obtain the vehicle location of the vehicle with high locating accuracy.

In some exemplary embodiments, the image sensor 210 is configured to send the environmental image to a cloud server, so that the cloud server matches the environmental image with a pre-generated navigation map to determine a cloud-side location of the vehicle. The cloud server may send the cloud-side location to the computing device 400. The computing device 400 may receive the cloud-side location, and determine and output the current vehicle location of the vehicle based on the vehicle-side location and the cloud-side location. In some exemplary embodiments of this disclosure, the location of the vehicle may be determined based on a combination of a visual image captured by the vehicle and the navigation map, thereby ensuring locating accuracy of the vehicle.

The environmental image may be a panoramic image or panoramic video around the vehicle. The cloud server is in communication with the image sensor 210 and the computing device 400 respectively. The pre-generated navigation map may be stored in the cloud server. The navigation map may be pre-generated and stored by the cloud server, or may be pre-generated by the vehicle and sent to the cloud server for storage. The navigation map may be a map including an operating range of the vehicle. For example, if an operating range of a shared three-wheel scooter is within XX city, the navigation map may be a map of XX city. After the cloud server matches the environmental image of the vehicle with the navigation map, the cloud server may determine the current location of the vehicle in the navigation map.

In some exemplary embodiments, the image sensor 210 may not send the environmental image to the cloud server, but sends it to the computing device 400. The computing device 400 may store the pre-generated navigation map, and match the environmental image with the navigation map to determine the location of the vehicle. Therefore, the computing device 400 may determine and output the current vehicle location of the vehicle based on the vehicle-side location and the location determined based on the environmental image.

In some exemplary embodiments, the computing device 400 may output the cloud-side location as the current vehicle location of the vehicle when the vehicle-side location determined by the vehicle-side locator 110 cannot meet a preset criterion.

That the vehicle-side location cannot meet a preset criterion may mean: the computing device 400 does not receive the vehicle-side location, or signal strength of the vehicle-side location received by the computing device 400 is less than preset strength. For example, when the vehicle-side locator 110 is damaged and cannot determine the vehicle-side location, the computing device 400 cannot receive the vehicle-side location. In this case, the computing device 400 cannot determine the current vehicle location of the vehicle based on the vehicle-side location, and thus may use the cloud-side location as the current vehicle location of the vehicle and output the cloud-side location. In another example, if certain interfering devices interfere with the vehicle-side location determined by the vehicle-side locator 110, the signal strength of the determined vehicle-side location may be very low. In this case, the computing device 400 cannot determine the current vehicle location of the vehicle based on the vehicle-side location either, and thus may use the cloud-side location as the current vehicle location of the vehicle and output the cloud-side location.

In some exemplary embodiments of this disclosure, when the computing device 400 cannot determine the vehicle-side location, the cloud-side location may be used for assisted locating, to avoid safety issues caused by the inability to determine the current vehicle location. For example, the computing device 400 may perform cloud-side-assisted locating in a timely manner based on a status of an RTK signal (that is, the vehicle-side location determined by the RTK locator) (the signal is not received or the signal strength is too low), and improve global locating solution accuracy when the RTK signal is lost or interfered. Therefore, based on the RTK signal and cloud-side visual assistance, the autonomous driving system can ensure the locating accuracy and a locating success rate of the vehicle.

In some exemplary embodiments, the computing device 400 may receive the vehicle-side location and the cloud-side location, and determine and output the current vehicle location based on fusion of the vehicle-side location and the cloud-side location. For example, the computing device 400 may perform weighted fusion on the vehicle-side location and the cloud-side location, and use a result of the weighted fusion as the current vehicle location.

In some exemplary embodiments of this disclosure, even if the vehicle-side location meets the foregoing preset criterion, the locating accuracy may be insufficient due to other factors. Therefore, to improve the locating accuracy of the vehicle, the computing device 400 may implement locating with a double guarantee, that is, determine the current vehicle location based on the fusion of the vehicle-side location and the cloud-side location, thereby improving the locating accuracy.

In some exemplary embodiments, the locating device 100 may include an inertial measurement device 120. As shown in FIG. 1, the inertial measurement device 120 is an IMU (inertial measurement unit), which may measure and record an acceleration, an angular velocity, and a gravity direction of the vehicle or a robot. The IMU may be in communication with the computing device 400 via an IIC (inter-integrated circuit). The locating device 100 may further include a wheel speed meter/cyclometer (not shown in FIG. 1). The inertial measurement device and the wheel speed meter/cyclometer may be configured to determine a location of the vehicle by dead reckoning. In some exemplary embodiments, the computing device 400 may determine the current vehicle location based on fusion of the vehicle-side location, the cloud-side location, and the reckoning location. For example, the computing device 400 may perform weighted fusion on the vehicle-side location, the cloud-side location, and the reckoning location, and use a result of the weighted fusion as the current vehicle location. In some exemplary embodiments of this disclosure, the locating accuracy is further improved by providing a triple guarantee for vehicle locating. Even if no LiDAR is installed on the vehicle during operation, accurate locating of the vehicle can be implemented at a low cost.

As described above, the sensing device 200 is configured to output environmental sensing data. The environmental sensing data may be environmental data around the vehicle or around the sensing device 200. The environmental data may be orientations of objects around the vehicle or around the sensing device 200, moving speeds of the objects, and the like. In some exemplary embodiments, the environmental sensing data may include a drivable area and a road boundary. The sensing device 200 may include a first sensing device. As shown in FIG. 1, the first sensing device includes the image sensor 210 and a depth camera 220. The first sensing device is configured to sense the drivable area and the road boundary.

In some exemplary embodiments of this disclosure, the system 001 may sense the drivable area and the road boundary by using the image sensor 210 and the depth camera 220, for example, sense objects around the vehicle 002 such as steps, pits, stones, pedestrians, and other vehicles by using the image sensor 210, and obtain distances between the vehicle 002 and the objects around the vehicle 002 by using the depth camera 220, thereby determining the drivable area and the road boundary by avoiding obstacles. The first sensing device senses the road environment around the vehicle, recognizes and determines the drivable area and the road boundary in the current driving environment through segmentation, and provides path planning assistance for autonomous driving, to prevent the vehicle from deviating from a lane or violating traffic regulations.

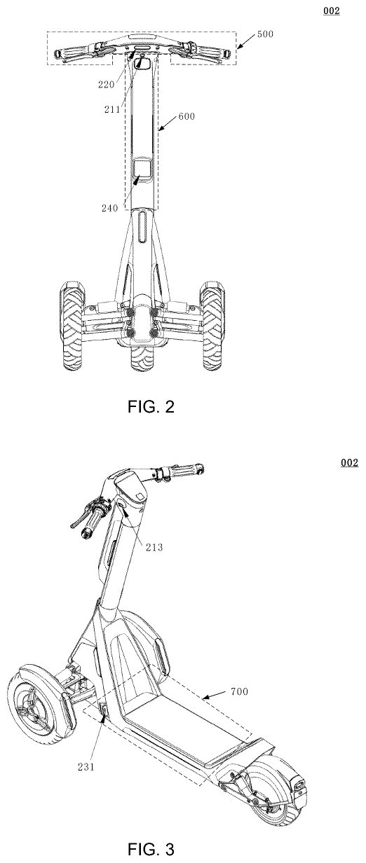

As described above, the image sensor 210 may be a surround-view camera, and the surround-view camera may include a plurality of cameras. FIG. 2 is a front view of a vehicle 002 according to some exemplary embodiments of this disclosure. As shown in FIG. 2, the vehicle 002 may include a vehicle front 500 of the vehicle and a riser 600. The vehicle front 500 of the vehicle is configured to control a rotation/turning direction of the vehicle 002, such as turning left, or turning right. The vehicle front 500 of the vehicle may include a pair of handles, a visual dial, a brake, and other components. The riser 600 is connected to the vehicle front 500 of the vehicle and rotates/turns with the vehicle front 500 of the vehicle. In some exemplary embodiments, the surround-view camera includes four cameras, which are respectively mounted on four sides of the riser 600. The four sides may be four directions during driving of the vehicle 002: directly front, directly rear, directly left, and directly right. As shown in FIG. 2, the depth camera 220 may be mounted directly in front of the vehicle front 500 of the vehicle.

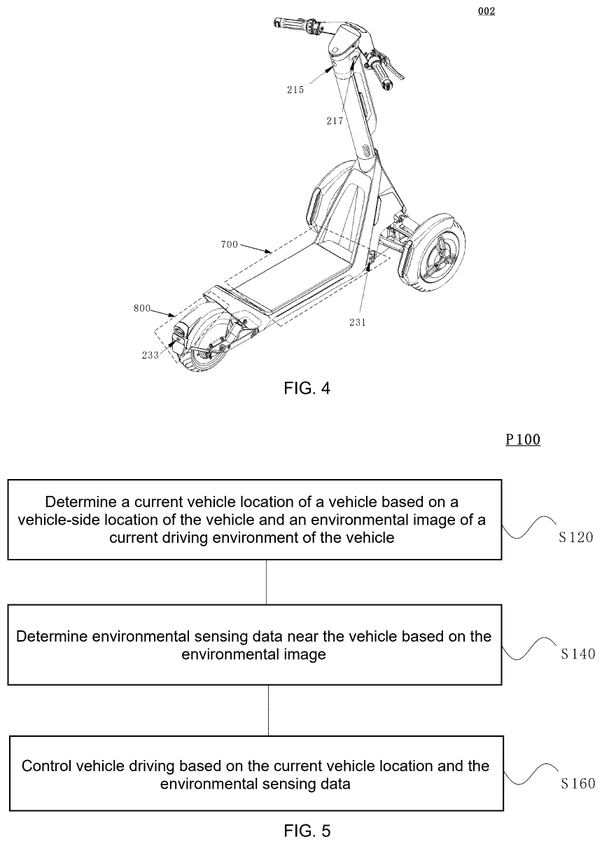

FIG. 3 is a first perspective view of a vehicle 002 according to some exemplary embodiments of this disclosure. FIG. 4 is a second perspective view of a vehicle 002 according to some exemplary embodiments of this disclosure. As shown in FIG. 2 to FIG. 4, the four cameras may be a front camera 211, a left camera 213, a rear camera 215, and a right camera 217. As shown in FIG. 2, the front camera 211 may be mounted directly in front of the riser 600. As shown in FIG. 3, the left camera 213 may be mounted directly on the left of the riser 600. As shown in FIG. 4, the rear camera 215 may be mounted directly behind the riser 600, and the right camera 217 may be mounted directly on the right of the riser 600. A panoramic image around the vehicle 002 may be captured by the surround-view camera.

A quantity of cameras in the image sensor 210 may be any quantity, and the mounting positions may be any positions. For example, the image sensor 210 may be a full ring camera, disposed in a circle around the riser 600 in a horizontal direction. In another example, the image sensor 210 includes three cameras, and the three cameras may also form a surround-view camera to capture a panoramic image. A quantity and mounting positions of image sensors 210 are not limited herein. The depth camera 220 may be a depth camera based on TOF (time-of-flight) or structured light. There may be a plurality of depth cameras 220, for example, two, where one is mounted directly in front of the vehicle front 500 of the vehicle, and the other is mounted directly behind the vehicle front 500 of the vehicle. A quantity and mounting positions of the depth cameras 220 are not limited in the embodiments of this disclosure.

In some exemplary embodiments of this disclosure, the surround-view camera provides a wide range of viewing angles and rich color and texture information, while the depth camera supplements accurate distance information. This combination enables the vehicle 002 to build a detailed three-dimensional scene understanding and accurately distinguish between the drivable area and obstacles. The surround-view disposition means that the camera covers a 360-degree field of view around the vehicle 002, almost without blind spots. In combination with depth information, it can effectively reduce or eliminate detection blind spots and improve safety. With reference to data of the two sensors, the vehicle 002 can make driving decisions more intelligently, such as using the depth information to assist in determining whether an area is a drivable area when road conditions are difficult to determine, or choosing an optimal path at a complex intersection. In some exemplary embodiments of this disclosure, the surround-view camera can provide rich color and texture information to help recognize road signs, lane lines, pedestrians, other vehicles, and the like, while the depth camera supplements accurate distance information. Although the surround-view camera may be affected by extreme light conditions, the depth camera that does not rely on light conditions can be used in combination to maintain stable sensing performance in various light environments, for example, at night or in direct sunlight, to improve adaptability to the light conditions. Moreover, the depth camera, and especially TOF and structured light technologies, can operate in dark or low-light environments, and cooperate with the surround-view camera to ensure reliable sensing of the driving environment day and night, providing the vehicle 002 with all-weather operating capabilities.

In some exemplary embodiments, the environmental sensing data includes moving obstacles located in front of the vehicle 002. The sensing device 200 includes a second sensing device. As shown in FIG. 1, the second sensing device may include the image sensor 210 and a millimeter-wave radar 240. The second sensing device is configured to sense the moving obstacles in front of the vehicle 002. The moving obstacles include at least pedestrians and other vehicles.

The millimeter-wave radar 240 refers to a radar technology that uses a millimeter-wave frequency band (usually a frequency range of 30 GHz to 300 GHZ, corresponding to a wavelength of 1 mm to 10 mm). The millimeter-wave radar 240 has a high resolution and accuracy. Due to its short wavelength characteristics, the millimeter-wave radar 240 can provide a high spatial resolution, can accurately distinguish and locate a small-sized target, and simultaneously recognize and track a plurality of targets. The millimeter-wave radar 240 is relatively small in size. Therefore, the millimeter-wave radar 240 can be more easily integrated into the vehicle 002, is more friendly to the appearance design, and is not prone to damage, thereby reducing maintenance costs. Costs of the millimeter-wave radar 240 are controllable and not easily affected by bad weather. The millimeter-wave radar 240 may be a 4D millimeter-wave radar for detecting and tracking objects, and can provide a sparse point cloud of a scene, where each point cloud includes x, y, and z three-dimensional position information and radial velocity information. The 4D millimeter-wave radar can determine speeds of other vehicles and draw a general contour of an obstacle such as a vehicle or people. Certainly, the millimeter-wave radar 240 may alternatively be a 3D millimeter-wave radar. The type of the millimeter-wave radar 240 is not limited in the embodiments of this disclosure.

In some exemplary embodiments of this disclosure, the image sensor 210 and the millimeter-wave radar 240 may be used in combination to complement advantages of each other and jointly enhance an environmental sensing capability of autonomous driving. The image sensor 210 can provide high-resolution visual information, can recognize colors, textures, and shapes, and therefore can effectively distinguish between pedestrians and vehicle types. The millimeter-wave radar 240 is specialized in providing accurate distance, speed, and angle information, and can operate reliably even in bad weather conditions such as low light, rain, fog, and snow. When the line of sight of the image sensor 210 is affected by factors such as strong light, backlight, darkness, or bad weather, the millimeter-wave radar 240 can still provide stable target detection and tracking to ensure reliability of the vehicle 002. The image sensor 210 has good performance in the daytime and under good light conditions, while the millimeter-wave radar 240 still operates stably at night or in bad weather. The combination of the two ensures the all-weather operating capabilities of the vehicle 002.

As shown in FIG. 2, the millimeter-wave radar 240 may be mounted in a position directly in front of the riser 600 and different from a mounting position of the image sensor 210. For example, the millimeter-wave radar 240 and the front camera 211 may be located in upper and lower positions in an area directly in front of the riser 600. Certainly, the millimeter-wave radar 240 may alternatively be mounted in other positions of the vehicle 002, for example, directly in front of a bracket connected to the riser 600.

In some exemplary embodiments of this disclosure, the surround-view disposition means that the camera covers a 360-degree field of view around the vehicle 002, almost without blind spots. In combination with radar information, it can effectively reduce or eliminate detection blind spots and improve safety. By combining data from the two sensors, the vehicle 002 can recognize potential collision risks earlier, provide more comprehensive protection for pedestrians and other road users, and enhance overall safety performance of the autonomous driving system 001. The surround-view camera has optimal performance in bright light and clear vision, but may be affected by night, backlight, strong light, or bad weather. However, the millimeter-wave radar 240 is almost not limited by these factors. The combination of the two ensures that moving obstacles can be reliably sensed under all environmental conditions.

In some exemplary embodiments, the environmental sensing data includes obstacles behind the vehicle. The sensing device 200 includes a third sensing device. The third sensing device may include at least one TOF camera 230. The third sensing device is configured to sense the obstacles behind the vehicle when the vehicle 002 is reversing. The TOF camera may emit continuous light pulses to a target object by a transmitter, receive reflected light through a sensor after the light pulses are reflected by the target object, and record the time of flight, thereby calculating a distance from the TOF camera to the target object. In some exemplary embodiments of this disclosure, the TOF camera can provide real-time and accurate distance measurement, which helps discover and evaluate locations of rear obstacles in time. Moreover, the TOF camera is less affected by changes of ambient light, and can operate stably regardless of strong light, dark light, or night, thereby improving safety in reversing of the vehicle. A TOF technology does not need to rely on feature points of objects, which means that the TOF camera can effectively recognize and measure distances regardless of a smooth wall, obstacles of a same color, or objects lacking textures. The TOF camera can detect a plurality of obstacles at different distances at the same time. This is particularly useful in complex parking environments. For example, in a crowded parking lot, a plurality of obstacles in close proximity can be effectively recognized.

In some exemplary embodiments, the third sensing device may include the image sensor 210 and at least one TOF camera 230. In some exemplary embodiments of this disclosure, the TOF camera 230 provides accurate depth information to quickly determine the distance of an obstacle. The image sensor 210 captures a high-resolution two-dimensional image to identify the type, color, texture, and other detailed features of the obstacle. This combination ensures that where and what the obstacle is can be both accurately known. With reference to data of the two sensors, the system 001 can analyze the scene more intelligently, for example, distinguish between static obstacles (such as pillars) and moving obstacles (such as pedestrians), to make a more reasonable driving assistance decision, for example, on whether emergency braking or adjusting a reversing path is required.

In some exemplary embodiments, the at least one TOF camera 230 may include a pair of front TOF cameras 231 and a rear TOF camera 233. The pair of front TOF cameras 231 may be mounted on both sides of a front end of a vehicle footboard. As shown in FIG. 3, the vehicle 002 includes a footboard 700, and a left TOF camera 231 of the pair of front TOF cameras 231 is mounted on a left side of the front end of the footboard 700. As shown in FIG. 4, a right TOF camera 231 of the pair of front TOF cameras 231 is mounted on a right side of the front end of the footboard 700. As shown in FIG. 4, the vehicle 002 includes a rear fender 800. The rear TOF camera 233 may be mounted on the rear fender 800 of a rear wheel of the vehicle. At least one TOF camera 230 may face the rear direction, that is, a viewing angle is toward the rear (directly rear or laterally rear) direction during driving of the vehicle 002. In some exemplary embodiments of this disclosure, a specific quantity and mounting positions of the TOF cameras 230 may be set based on characteristics of the vehicle 002, so that the quantity and mounting of the TOF cameras 230 adapt to the vehicle 002. The quantity and mounting positions of the TOF cameras 230 are not limited herein.

In some exemplary embodiments, the system 001 may include a LIDAR offline installation interface. The LiDAR may be installed by using the LiDAR offline installation interface when the vehicle 002 is in a non-operating state. The LiDAR is configured to collect point cloud data of the driving environment of the vehicle 002 offline in the non-operating state, and the point cloud data is used to generate the navigation map of the driving environment.

As shown in FIG. 1, a broken line box is used to indicate that the LiDAR is installed on the system 001 in the non-operating state of the vehicle (a state in which the user cannot use the vehicle). The LiDAR may be a 32-line LiDAR, a 16-line LIDAR, a 64-line LiDAR, or the like. Specifically, the LiDAR may collect the point cloud data of the driving environment of the vehicle 002 offline and send the point cloud data to the cloud server, and the cloud server may generate the navigation map based on the point cloud data. The LiDAR may alternatively send the point cloud data collected offline to the computing device 400 through an Ethernet, and the computing device 400 sends the point cloud data to the cloud server to generate the navigation map. Certainly, the computing device 400 may also generate the navigation map based on the point cloud data.

In some exemplary embodiments of this disclosure, a plug-in LiDAR is designed for assembly. When installed, the operating vehicle is transformed into a map data collection apparatus. During operation, the LiDAR is not installed. To be specific, the LiDAR is installed only when the vehicle 002 collects data offline, so that the costs are low. Because the vehicle 002 may be in a state in which use of the vehicle by the user (not an operator) is prohibited when the vehicle collects data offline, the vehicle is not prone to damage caused by human factors. Moreover, in this case, the vehicle 002 may still be within the line of sight of the operator, and therefore is not likely to be lost.

The system 001 obtains the navigation map by using the LiDAR installed on the vehicle 002, so that a viewing angle of the environmental image captured by the image sensor 210 when the vehicle 002 is in operation is the same as or similar to that of the navigation map, thereby reducing or even eliminating coordinate conversion calculation during locating and improving efficiency.

In some exemplary embodiments, the system 001 may alternatively not include the LiDAR offline installation interface. The navigation map may be generated by other means. For example, an image sensor or a LIDAR is mounted on a dedicated road detection device, and road surface data may be obtained through the road detection device to generate a navigation map. For example, a navigation map is obtained from a map tool.

In some exemplary embodiments, the computing device 400 is configured to output a driving instruction based on the current vehicle location and the environmental sensing data, where the driving instruction includes a driving route and a driving speed. The control device 300 is configured to control vehicle driving based on the driving instruction. As shown in FIG. 1, the computing device 400 may be in communication with the control device 300, for example, through a SPI (serial peripheral interface). A model of the computing device 400 may be QCS8250.

In some exemplary embodiments, the computing device 400 may determine a global path based on the current vehicle location, the pre-generated navigation map, and a destination location. The global path may be an overall route plan in the navigation of the vehicle 002, usually covering a complete route from a starting point to a destination. The computing device 400 may determine a driving decision behavior based on the global path and the environmental sensing data, where the driving decision behavior includes at least one of yielding, detouring, going straight, following, changing lanes, or borrowing lanes. Further, the computing device 400 may output the driving instruction based on the driving decision behavior. For example, a specific driving route and a speed control requirement of a local path are planned based on the driving decision behavior and the current driving environment. The local path may be a short-term route plan in the navigation of the vehicle 002, usually guiding the vehicle 002 on how to reach a next landmark at a current location.

As shown in FIG. 1, the control device 300 may include a controller 310 (such as an STM 32 controller). The control device 300 may further include a steering device 320 and a motor controller 330. The steering device 320 may be an EPS (electric power steering) system, which may assist the vehicle 002 in steering with electric power. The steering device 320 is configured to control a driving direction of the vehicle based on the driving route. The motor controller 330 may be an ECU (electronic control unit), configured to control an electronic system and functions of the vehicle 002. The motor controller 330 is configured to control vehicle driving based on the driving speed. The controller 310 may be in communication with the steering device 320 and the motor controller 330 through a CAN bus.

In some exemplary embodiments of this disclosure, the autonomous driving of the vehicle 002 is achieved through the cooperation between the computing device 400 and the control device 300.

FIG. 5 is a flowchart of an autonomous vehicle driving method P100 according to some exemplary embodiments of this disclosure. The method P100 may be performed by an autonomous driving system 001. Specifically, a computing device 400 may perform the method P100, for example, read an instruction set stored in a local storage medium of the computing device 400 through an internal processor, and then perform the method P100 as specified by the instruction set. As shown in FIG. 5, the method P100 may include the following steps.

S120. Determine a current vehicle location of a vehicle based on a vehicle-side location of the vehicle and an environmental image of a current driving environment of the vehicle.

The computing device 400 may determine the current vehicle location of the vehicle by using a locating device 100.

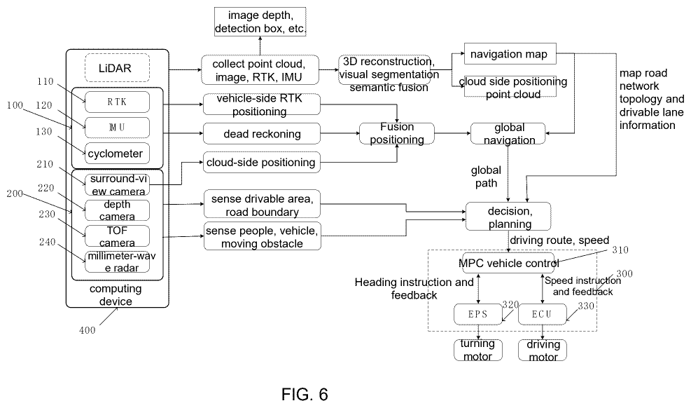

FIG. 6 is a schematic flowchart of an autonomous vehicle driving method according to some exemplary embodiments of this disclosure. In some exemplary embodiments, the computing device 400 may control an image sensor 210 to send an environmental image to a cloud server. As shown in FIG. 6, the image sensor 210 is a surround-view camera, and the surround-view camera may send the environmental image to the cloud server. The cloud server may match the environmental image with a pre-generated navigation map to determine a cloud-side location of the vehicle 002. The computing device 400 may receive the cloud-side location sent by the cloud server, and determine the current vehicle location based on the vehicle-side location of the vehicle and the cloud-side location. In some exemplary embodiments of this disclosure, the location of the vehicle may be determined based on a combination of a visual image captured by the vehicle and the navigation map, thereby ensuring locating accuracy of the vehicle.

The vehicle 002 may collect point cloud data of the driving environment of the vehicle 002 offline by using a LIDAR installed when the vehicle 002 is in a non-operating state, where the point cloud data is used to generate the navigation map of the driving environment. The vehicle 002 may generate the navigation map and send the navigation map to the cloud server, or send the point cloud data to the cloud server, so that the cloud server generates the navigation map.

As shown in FIG. 6, the LiDAR may collect LiDAR point clouds offline, perform scene 3D point cloud reconstruction, and visual segmentation and semantic fusion, to generate the navigation map. When determining to assist in determining the vehicle-side location based on the cloud-side location, the computing device 400 may collect data from an RTK locator, data from an IMU, and the like, to determine a situation of the vehicle-side location. The computing device 400 may further collect image data (an environmental image), and by matching image data with the navigation map, determine the cloud-side location, thereby achieving cloud-side visual assisted locating. People, other vehicles, ground, trees, grass, and the like in the navigation map may be distinguished through visual segmentation and semantic fusion. In addition, the cloud server may annotate an image depth, a detection box, and a segmentation truth value based on the point cloud data of the LiDAR.

In some exemplary embodiments, the computing device 400 may output the cloud-side location as the current vehicle location when a vehicle-side location of a vehicle-side locator 110 does not meet a preset criterion, for example, when the vehicle-side locator 110 fails (for example, due to damage or failure). In some exemplary embodiments, the computing device 400 may determine and output the current vehicle location based on fusion of the vehicle-side location and the cloud-side location.

In some exemplary embodiments, the computing device 400 may determine a reckoning location of the vehicle by dead reckoning, and determine and output the current vehicle location based on fusion of the vehicle-side location, the cloud-side location, and the reckoning location. The computing device 400 may control an inertial measurement device 120 and a wheel speed meter/cyclometer 130 to perform dead reckoning. As shown in FIG. 6, the IMU and the wheel speed meter/cyclometer perform dead reckoning. The computing device 400 may perform vehicle-side RTK combined locating based on an RTK locator 110, dead reckoning based on the IMU 120 and the wheel speed meter/cyclometer 130, and cloud-side visual assisted locating based on the surround-view camera 210, thereby performing fused locating based on the three to determine the current vehicle location.

A specific technical process for determining the current vehicle location has been described in detail above and is not described herein again.

S140. Determine environmental sensing data near the vehicle based on the environmental image.

The computing device 400 may determine the environmental sensing data near the vehicle through a sensing device 200.

The computing device 400 may obtain the environmental image through the image sensor 210. The computing device 400 may obtain a depth image through a depth camera 220, and therefore determine a drivable area and a road boundary based on the environmental image and the depth image, where the environmental sensing data includes the drivable area and the road boundary. As shown in FIG. 6, the sensing device 200 senses the drivable area and the road boundary.

The computing device 400 may obtain a millimeter-wave radar image through a millimeter-wave radar 240, thereby determining moving obstacles based on the environmental image and the millimeter-wave radar image, where the moving obstacles include at least pedestrians and other vehicles, and the environmental sensing data includes the moving obstacles. As shown in FIG. 6, the sensing device 200 senses moving obstacles such as pedestrians and vehicles.

The computing device 400 may obtain at least one TOF image through a TOF camera 230. The computing device 400 may determine obstacles behind the vehicle based on the environmental image and the at least one TOF image when the vehicle 002 is reversing, where the environmental sensing data includes the obstacles behind the vehicle.

A specific technical process for determining the environmental sensing data has been described in detail above and is not described herein again.

S160. Control vehicle driving based on the current vehicle location and the environmental sensing data.

The computing device 400 may output a driving instruction based on the current vehicle location and the environmental sensing data, where the driving instruction includes a driving route and a driving speed, to control a control device 300 to control vehicle driving based on the driving instruction.

In some exemplary embodiments, the computing device 400 may determine a global path based on the current vehicle location, the pre-generated navigation map, and a destination location. As shown in FIG. 6, the global path is determined through global navigation. The navigation map may include a map road network topology and drivable lane information, which are helpful for global navigation. The map road network topology is a structural representation of a road network, describing a connection and relationship between lanes. The computing device 400 may determine a driving decision behavior based on the global path and the environmental sensing data, where the driving decision behavior includes at least one of yielding, detouring, going straight, following, changing lanes, or borrowing lanes. As shown in FIG. 6, a driving decision behavior, that is, a behavior decision, is determined based on the global path, the sensed drivable area and road boundary, and the moving obstacles such as pedestrians and other vehicles. Further, the computing device 400 may output the driving instruction based on the driving decision behavior. As shown in FIG. 6, local planning is performed based on the driving decision behavior and the current driving environment to plan a driving route and driving speed for a local path.

The control device 300 may control a driving direction of the vehicle based on the driving route. As shown in FIG. 6, the vehicle receives, in real time through MPC (Model Predictive Control, model predictive control), steering information fed back by an EPS, and sends a heading angle instruction to the EPS, and the EPS controls a steering motor to perform a steering action. The control device 300 may control vehicle driving based on the driving speed. As shown in FIG. 6, the vehicle receives, in real time through MPC, speed information fed back by an ECU, and sends acceleration and speed instructions to the ECU. The ECU controls a power motor to drive at a corresponding speed.

A specific technical process for controlling vehicle driving has been described in detail above and is not described herein again.

In the autonomous vehicle driving method P100 provided in this disclosure, the vehicle is located by using the vehicle-side location determined by the vehicle-side locator based on a differential operation and the environmental image of the current driving environment of the vehicle, that is, the current vehicle location of the vehicle is determined, so that accuracy of vehicle locating is ensured. The environmental sensing data near the vehicle is determined based on the environmental image. Further, vehicle driving is controlled based on the current vehicle location and the environmental sensing data, and autonomous driving can be implemented without a LIDAR during vehicle operation, thereby reducing costs without affecting the appearance and use of the vehicle.

Specific embodiments of this disclosure are described above. Other embodiments also fall within the scope of the appended claims. In some cases, the actions or steps described in the claims may be implemented in an order different from the order in some exemplary embodiments and the expected results can still be achieved. In addition, the processes depicted in the drawings do not necessarily require a specific order or sequence to achieve the expected results. In some implementations, multitask processing and parallel processing are also possible or may be advantageous.

In summary, after reading this detailed disclosure, a person skilled in the art may understand that the foregoing detailed disclosure may be presented by using examples only, and may not be restrictive. A person skilled in the art may understand that this disclosure needs to cover various reasonable changes, improvements, and modifications to the embodiments, although this is not specified herein. These changes, improvements, and modifications are intended to be proposed in this disclosure and are within the spirit and scope of the exemplary embodiments of this disclosure.

In addition, some terms in this disclosure are used to describe the embodiments of this disclosure. For example, “one embodiment”, “an embodiment”, and/or “some exemplary embodiments” mean/means that a specific feature, structure, or characteristic described with reference to the embodiment(s) may be included in at least one embodiment of this disclosure. Therefore, it may be emphasized and should be understood that in various parts of this disclosure, two or more references to “an embodiment” or “one embodiment” or “an alternative embodiment” do not necessarily all refer to the same embodiment. In addition, specific features, structures, or characteristics may be appropriately combined in one or more embodiments of this disclosure.

It should be understood that in the foregoing description of the embodiments of this disclosure, to help understand one feature, for the purpose of simplifying this disclosure, various features in this disclosure are combined in a single embodiment, single drawing, or description thereof. However, this does not mean that the combination of these features is necessary. It is entirely possible for a person skilled in the art to mark out some of the devices as a separate embodiment for understanding when reading this disclosure. In other words, some exemplary embodiments in this disclosure may also be understood as an integration of a plurality of sub-embodiments. It is also true when content of each sub-embodiment is less than all features of a single embodiment disclosed above.

Each patent, patent application, patent application publication, and other materials cited herein, such as articles, books, specifications, publications, documents, and materials, except any historical prosecution document associated therewith, any identical historical prosecution document that may be inconsistent or conflicting with this document, or any identical historical prosecution document that may have a restrictive effect on the broadest scope of the claims, can be incorporated herein by reference and used for all purposes associated with this document at present or in the future. In addition, if there is any inconsistency or conflict in descriptions, definitions, and/or use of a term associated with this document and descriptions, definitions, and/or use of the term associated with any material, the term in this document shall prevail.

Finally, it should be understood that the implementation solutions of this disclosure disclosed herein illustrate the principles of the implementation solutions of this disclosure. Other modified embodiments shall also fall within the scope of this disclosure. Therefore, the embodiments disclosed in this disclosure are merely exemplary and not restrictive. A person skilled in the art may use alternative configurations for implementation according to the embodiments of this disclosure. Therefore, the embodiments of this disclosure are not limited to those embodiments precisely described in this disclosure.

What is claimed is:

1. An autonomous vehicle driving system, comprising:
a sensing device including an image sensor, wherein the sensing device is configured to output environmental sensing data;
a locating device, including:
a vehicle-side locator, configured to determine a vehicle-determined location of a vehicle based on a differential operation, and
the image sensor, configured to capture an environmental image of a driving environment of the vehicle, wherein the vehicle-determined location and the environmental image are used to determine a current vehicle location of the vehicle; and
a control device, configured to control vehicle driving based on the current vehicle location and the environmental sensing data.

2. The autonomous vehicle driving system according to claim 1, wherein
the vehicle includes a public vehicle, and the control device is configured to control the public vehicle to drive from a non-public parking area to a public parking area, or control the public vehicle to drive from one public parking area to another public parking area; or
the vehicle includes a private vehicle, and the control device is configured to control the private vehicle to drive from a non-designated parking area to a designated parking area, wherein the designated parking area includes a dedicated parking space for the private vehicle and any vacant parking space in a parking area in which the private vehicle is authorized to park.

3. The autonomous vehicle driving system according to claim 1, wherein
the image sensor is configured to send the environmental image to a cloud server, so that the cloud server matches the environmental image with a pre-generated navigation map to determine a cloud-determined location of the vehicle; and
the autonomous driving system further comprises a computing device, wherein the computing device is configured to receive the cloud-determined location, and determine and output the current vehicle location of the vehicle based on the vehicle-determined location and the cloud-determined location, wherein
the computing device is configured to output the cloud-determined location as the current vehicle location when the vehicle-determined location does not meet a preset criterion, or
the computing device is configured to receive the vehicle-determined location and the cloud-determined location, and determine and output the current vehicle location based on fusion of the vehicle-determined location and the cloud-determined location.

4. The autonomous vehicle driving system according to claim 3, wherein the locating device further includes at least one of an inertial measurement device or a cyclometer, configured to determine a reckoning location of the vehicle by dead reckoning; and
the computing device is configured to determine and output the current vehicle location based on fusion of the vehicle-determined location, the cloud-determined location, and the reckoning location.

5. The autonomous vehicle driving system according to claim 1, wherein the environmental sensing data includes a drivable area and a road boundary;
the sensing device includes a first sensing device, wherein the first sensing device includes the image sensor and a depth camera, and the first sensing device is configured to sense the drivable area and the road boundary;
the image sensor includes a surround-view camera, the surround-view camera includes four cameras respectively mounted in four directions, directly front, directly rear, directly left, and directly right, of a riser of the vehicle; and
the depth camera is mounted directly in front of a vehicle front of the vehicle, wherein
the vehicle front is configured to control a turning direction of the vehicle, the riser is connected to the vehicle front to and turn along with the vehicle front.

6. The autonomous vehicle driving system according to claim 1, wherein the environmental sensing data includes a moving obstacle located in front of the vehicle;
the sensing device includes a second sensing device, wherein the second sensing device includes the image sensor and a millimeter-wave radar, the second sensing device is configured to sense the moving obstacle, and the moving obstacle includes at least one of a pedestrian, or another vehicle;
the image sensor includes a surround-view camera, wherein the surround-view camera includes four cameras respectively mounted in four directions, directly front, directly rear, directly left, and directly right, of a riser of the vehicle; and
the millimeter-wave radar is mounted in a position directly in front of the riser and different from a mounting position of the image sensor.

7. The autonomous vehicle driving system according to claim 1, wherein the environmental sensing data includes an obstacle behind the vehicle; and
the sensing device includes a third sensing device, wherein the third sensing device includes at least one time-of-flight (TOF) camera, and the third sensing device is configured to sense the obstacle behind the vehicle when the vehicle is reversing wherein,
the at least one TOF camera includes:
a pair of front TOF cameras respectively mounted on two sides of a front end of a vehicle footboard; and
a rear TOF camera, mounted on a rear fender of a rear wheel of the vehicle.

8. The autonomous vehicle driving system according to claim 1, further comprising:
a LIDAR offline installation interface, configured to install a LIDAR when the vehicle is in a non-operating state, wherein the LiDAR is configured to offline-collect point cloud data of the driving environment of the vehicle in the non-operating state, and the point cloud data is used to generate a navigation map of the driving environment.

9. The autonomous vehicle driving system according to claim 1, further comprising:
a computing device, configured to output a driving instruction based on the current vehicle location and the environmental sensing data, wherein
the driving instruction includes a driving route and a driving speed, and
the control device is configured to control the vehicle based on the driving instruction.

10. The autonomous vehicle driving system according to claim 9, wherein
the computing device is configured to: determine a global path based on the current vehicle location, a pre-generated navigation map, and a destination location, determine a driving decision based on the global path and the environmental sensing data, wherein the driving decision includes at least one of yielding, detouring, going straight, following, changing lanes, or borrowing lanes, and output the driving instruction based on the driving decision;
the control device includes: a steering device, configured to control a driving direction of the vehicle based on the driving route, and a motor controller, configured to control the vehicle driving based on the driving speed.

11. An autonomous vehicle driving method for an autonomous driving system, comprising:
determining a current vehicle location of a vehicle based on a vehicle-determined location of the vehicle and an environmental image of a driving environment of the vehicle;
determining environmental sensing data around the vehicle based on the environmental image; and
controlling vehicle driving based on the current vehicle location and the environmental sensing data.

12. The autonomous vehicle driving method according to claim 11, wherein the determining of the current vehicle location of the vehicle based on the vehicle-determined location of the vehicle and the environmental image of the driving environment of the vehicle includes:
sending the environmental image to a cloud server, so that the cloud server matches the environmental image with a pre-generated navigation map to determine a cloud-determined location of the vehicle;
receiving the cloud-determined location sent by the cloud server; and
determining the current vehicle location based on the vehicle-determined location of the vehicle and the cloud-determined location.

13. The autonomous vehicle driving method according to claim 12, further comprising:
offline-collecting point cloud data of the driving environment of the vehicle by using a LIDAR installed when the vehicle is in a non-operating state, wherein the point cloud data is used to generate a navigation map of the driving environment, wherein
the determining of the current vehicle location based on the vehicle-side location of the vehicle and the cloud-side location includes:
outputting the cloud-determined location as the current vehicle location when the vehicle-determined location does not meet a preset criterion, or
determining and outputting the current vehicle location based on fusion of the vehicle-determined location and the cloud-determined location, or
determining a reckoning location of the vehicle by dead reckoning, and determining and outputting the current vehicle location based on fusion of the vehicle-determined location, the cloud-determined location, and the reckoning location.

14. The autonomous vehicle driving method according to claim 11, wherein the determining of the environmental sensing data based on the environmental image includes:
obtaining a depth image; and
determining a drivable area and a road boundary based on the environmental image and the depth image, wherein the environmental sensing data includes the drivable area and the road boundary.

15. The autonomous vehicle driving method according to claim 11, wherein the determining of the environmental sensing data based on the environmental image includes:
obtaining a millimeter-wave radar image; and
determining a moving obstacle based on the environmental image and the millimeter-wave radar image, wherein the moving obstacle includes at least one of a pedestrian, or another vehicle, and the environmental sensing data includes the moving obstacle.

16. The autonomous vehicle driving method according to claim 11, wherein the determining of the environmental sensing data based on the environmental image includes:
obtaining at least one TOF image; and
determining an obstacle behind the vehicle based on the environmental image and the at least one TOF image when the vehicle is reversing, wherein the environmental sensing data includes the obstacle behind the vehicle.

17. The autonomous vehicle driving method according to claim 11, wherein the controlling of vehicle driving based on the current vehicle location and the environmental sensing data includes:
outputting a driving instruction based on the current vehicle location and the environmental sensing data, wherein the driving instruction includes a driving route and a driving speed; and
controlling the vehicle driving based on the driving instruction.

18. The autonomous vehicle driving method according to claim 17, wherein
the outputting of the driving instruction based on the current vehicle location and the environmental sensing data includes: determining a global path based on the current vehicle location, the pre-generated navigation map, and a destination location, determining a driving decision based on the global path and the environmental sensing data, wherein the driving decision includes at least one of yielding, detouring, going straight, following, changing lanes, or borrowing lanes, and outputting the driving instruction based on the driving decision;
the controlling of the vehicle driving based on the driving instruction includes: controlling a driving direction of the vehicle based on the driving route, and controlling the vehicle driving based on the driving speed.

19. The autonomous vehicle driving method according to claim 11, wherein the vehicle includes a public vehicle; and
the controlling of the vehicle driving based on the current vehicle location and the environmental sensing data includes:
controlling the public vehicle to drive from a non-public parking area to a public parking area, or controlling the public vehicle to drive from one public parking area to another public parking area.

20. The autonomous vehicle driving method according to claim 11, wherein the vehicle includes a private vehicle; and the controlling of the vehicle driving based on the current vehicle location and the environmental sensing data includes:
controlling the private vehicle to drive from a non-designated parking area to a designated parking area, wherein the designated parking area includes a dedicated parking space for the private vehicle and any vacant parking space in a parking area in which the private vehicle is authorized to park.
